(19) United States
(12) Patent Application Publication
(10) Pub. No.: US 2019/0004920 A1
(43) Pub. Date: Jan. 3, 2019

(54) TECHNOLOGIES FOR PROCESSOR SIMULATION MODELING WITH MACHINE LEARNING

(71) Applicant: Intel Corporation, Santa Clara, CA (US)

(72) Inventors: Yves Vandriessche, Kontich (BE); Wim Heirman, Ghent (BE); Ibrahim Hur, Leuven (BE); Kristof du Bois, Aalst (BE); Stijn Eyerman, Evergem (BE)

(21) Appl. No.: 15/638,727

(22) Filed: Jun. 30, 2017

(51) Int. Cl. G06F 11/34; G06F 17/50; G06N 99/00

(52) U.S. Cl. CPC G06F 11/3447; G06F 17/5031; G06F 8/443; G06F 11/3461; G06N 99/005

(57) ABSTRACT

Technologies for processor architecture simulation with machine learning include a computing device that simulates performance of a processor executing training programs with a simulation model. The computing device captures ground truth performance statistics of the processor executing the training programs, for example using a cycle-accurate simulator. The computing device collects training simulation statistics from the simulation model and trains an error model with the training simulation statistics as feature vector and with the ground truth performance statistics. The computing device may simulate performance of the processor executing a test program, capture test simulation statistic from the simulation model, and predict a predicted error of the simulation model using the error model with the test simulation statistics as feature vector. The computing device may adjust output of the simulation model or adapt execution of the simulation model based on the predicted error. Other embodiments are described and claimed.

### BACKGROUND

Processor architecture performance simulation is commonly used for design, validation, and/or testing of new and existing processor architectures. Typically, cycle-accurate simulation provides accurate simulation results but requires long execution time. Application-scope simulators improve simulation speed by abstracting, approximating, or otherwise modeling performance of the processor. By improving simulation speed, an application-scope simulator may be capable of simulating execution of an entire application executing on multiple processor cores in a reasonable amount of time. Due to abstraction and/or approximation, application-scope simulators are typically not as accurate as cycle-accurate simulation.

### BRIEF DESCRIPTION OF THE DRAWINGS

The concepts described herein are illustrated by way of example and not by way of limitation in the accompanying figures. For simplicity and clarity of illustration, elements illustrated in the figures are not necessarily drawn to scale. Where considered appropriate, reference labels have been repeated among the figures to indicate corresponding or analogous elements.

FIG. 1 is a simplified block diagram of at least one embodiment of a computing device for processor simulation modeling with machine learning;

FIG. 2 is a simplified block diagram of at least one embodiment of an environment that may be established by the computing device of FIG. 1;

FIG. 3 is a simplified flow diagram of at least one embodiment of a method for processor simulation modeling with machine learning that may be executed by the computing device of FIGS. 1-2;

FIG. 4 is a simplified flow diagram of at least one embodiment of a method for offline error model training that may be executed by the computing device of FIGS. 1-2;

FIG. 5 is a simplified flow diagram of at least one embodiment of a method for online error model training that may be executed by the computing device of FIGS. 1-2;

FIG. 6 is a simplified flow diagram of at least one embodiment of a method for offline simulation error correction that may be executed by the computing device of FIGS. 1-2; and

FIG. 7 is a simplified flow diagram of at least one embodiment of a method for hybrid/online simulation error correction that may be executed by the computing device of FIGS. 1-2.

### DETAILED DESCRIPTION OF THE DRAWINGS

While the concepts of the present disclosure are susceptible to various modifications and alternative forms, specific embodiments thereof have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described. Additionally, it should be appreciated that items included in a list in the form of “at least one of A, B, and C” can mean (A); (B); (C); (A and B); (A and C); (B and C); or (A, B, and C). Similarly, items listed in the form of “at least one of A, B, or C” can mean (A); (B); (C); (A and B); (A and C); (B and C); or (A, B, and C).

The disclosed embodiments may be implemented, in some cases, in hardware, firmware, software, or any combination thereof. The disclosed embodiments may also be implemented as instructions carried by or stored on one or more transitory or non-transitory machine-readable (e.g., computer-readable) storage media, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features.

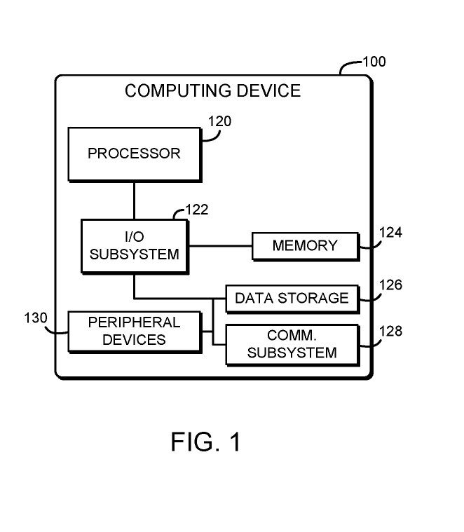

Referring now to FIG. 1, in an illustrative embodiment, a computing device 100 for processor simulation modeling with machine learning is shown. In use, as described further below, the computing device 100 uses an application-level simulation model to simulate execution of multiple training programs by a simulated processor. The computing device 100 also collects ground truth simulation results for the training programs, for example from a cycle-accurate simulator. The computing device 100 trains an error model using performance statistics from the simulation model against the ground truth simulation results. The simulation model is an application-level processor simulator, and the error model is a machine learning regression model. Thus, the error model essentially learns the error in simulation introduced by structures and/or other effects that are not captured by the simulation model. After error model training, the computing device 100 may use the simulation model to simulate execution of a test program, predict an error of the simulation model using the trained error model, and adjust output of the simulation model based on the predicted error. Accordingly, the computing device 100 may improve the accuracy of fast architecture-level simulation without adding to simulation speed. For example, a typical application-level simulation model may have an accuracy loss of about 20% compared to cycle-accurate simulation, while the computing device 100 may provide an accuracy loss of less than 10% compared to cycle-accurate simulation, without a significant decrease in simulation speed. As described below, error correction may be performed in an offline mode (after simulation), or in an online/hybrid mode (during simulation). Error correction during simulation may improve simulation results, particularly for applications that synchronize often between threads or processes.

The computing device 100 may be embodied as any type of computation or computer device capable of performing the functions described herein, including, without limitation, a computer, a server, a workstation, a desktop computer, a laptop computer, a notebook computer, a tablet computer, a mobile computing device, a wearable computing device, a network appliance, a web appliance, a distributed computing system, a processor-based system, and/or a consumer electronic device. As shown in FIG. 1, the computing device 100 illustratively include a processor 120, an input/output subsystem 122, a memory 124, a data storage device 126, and a communication subsystem 128, and/or other components and devices commonly found in a server computer or similar computing device. Of course, the computing device 100 may include other or additional components, such as those commonly found in a server computer (e.g., various input/output devices), in other embodiments. Additionally, in some embodiments, one or more of the illustrative components may be incorporated in, or otherwise form a portion of, another component. For example, the memory 124, or portions thereof, may be incorporated in the processor 120 in some embodiments.

The processor 120 may be embodied as any type of processor capable of performing the functions described herein. The processor 120 may be embodied as a single or multi-core processor(s), digital signal processor, microcontroller, or other processor or processing/controlling circuit. Additionally or alternatively, in some embodiments the processor 120 may be embodied as multiple processers of multiple computing devices in a datacenter. Similarly, the memory 124 may be embodied as any type of volatile or non-volatile memory or data storage capable of performing the functions described herein. In operation, the memory 124 may store various data and software used during operation of the computing device 100, such as operating systems, applications, programs, libraries, and drivers. The memory 124 is communicatively coupled to the processor 120 via the I/O subsystem 122, which may be embodied as circuitry and/or components to facilitate input/output operations with the processor 120, the memory 124, and other components of the computing device 100. For example, the I/O subsystem 122 may be embodied as, or otherwise include, memory controller hubs, input/output control hubs, platform controller hubs, integrated control circuitry, firmware devices, communication links (i.e., point-to-point links, bus links, wires, cables, light guides, printed circuit board traces, etc.) and/or other components and subsystems to facilitate the input/output operations. In some embodiments, the I/O subsystem 122 may form a portion of a system-on-a-chip (SoC) and be incorporated, along with the processor 120, the memory 124, and other components of the computing device 100, on a single integrated circuit chip.

The data storage device 126 may be embodied as any type of device or devices configured for short-term or long-term storage of data such as, for example, memory devices and circuits, memory cards, hard disk drives, solid-state drives, or other data storage devices. The communication subsystem 128 of the computing device 100 may be embodied as any communication circuit, device, or collection thereof, capable of enabling communications between the computing device 100 and other remote devices over a network. The communication subsystem 128 may be configured to use any one or more communication technology (e.g., wired or wireless communications) and associated protocols (e.g., Ethernet, InfiniBand®, Bluetooth®, Wi-Fi®, WiMAX, etc.) to effect such communication.

As shown, the computing device 100 may also include one or more peripheral devices 130. The peripheral devices 130 may include any number of additional input/output devices, interface devices, and/or other peripheral devices. For example, in some embodiments, the peripheral devices 130 may include a display, touch screen, graphics circuitry, keyboard, mouse, speaker system, microphone, network interface, and/or other input/output devices, interface devices, and/or peripheral devices.

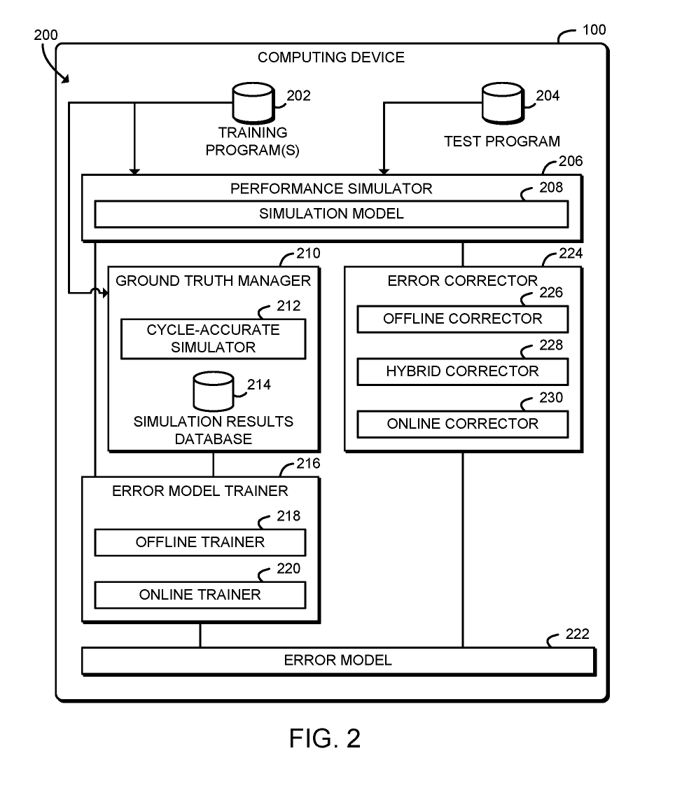

Referring now to FIG. 2, in an illustrative embodiment, the computing device 100 establishes an environment 200 during operation. The illustrative environment 200 includes a performance simulator 206, a ground truth manager 210, an error model trainer 216, and an error corrector 224. The various components of the environment 200 may be embodied as hardware, firmware, software, or a combination thereof. As such, in some embodiments, one or more of the components of the environment 200 may be embodied as circuitry or collection of electrical devices (e.g., performance simulator circuitry 206, ground truth manager circuitry 210, error model trainer circuitry 216, and/or error corrector circuitry 224). It should be appreciated that, in such embodiments, one or more of the performance simulator circuitry 206, the ground truth manager circuitry 210, the error model trainer circuitry 216, and/or the error corrector circuitry 224 may form a portion of one or more of the processor 120, the I/O subsystem 122, the communication subsystem 128, and/or other components of the computing device 100. Additionally, in some embodiments, one or more of the illustrative components may form a portion of another component and/or one or more of the illustrative components may be independent of one another.

The performance simulator 206 is configured to simulate performance of a processor with a simulation model 208 to determine a performance statistic. The performance simulator 206 simulates the performance of a processor architecture during execution of an application, such as one or more training programs 202 or a test program 204. The simulation model 208 may be embodied as an application-level processor architecture performance simulator for a particular simulated processor architecture. The performance statistic may be embodied as, for example, a cycles per instruction value, a floating point operations per second value, a power consumption value, a memory bandwidth value, or other performance statistic generated by the simulation model 208. The programs 202, 204 may be embodied as any executable code, object code, assembly code, or other computer program capable of being executed by the simulated processor architecture. In particular, the programs 202, 204 may be embodied as complete, multi-threaded or multi-process applications that may be executed by multiple processor cores. In some embodiments, the performance simulator 206 may be further configured to store simulation statistics and performance statistics in response to completion of the simulation. In some embodiments, the performance simulator 206 may be configured to simulate performance of the processor for a time interval of an application (e.g., one of the programs 202, 204) with the simulation model 208 to determine a performance statistic for the time interval.

The ground truth manager 210 is configured to collect a ground truth performance statistic of the simulated processor during execution of an application (e.g., the training programs 202). In some embodiments, the ground truth performance statistic may be collected by executing a cycle-accurate simulation of the training program 202 using a cycle-accurate simulator 212. In some embodiments, the ground truth performance statistic may be collected by reading a pre-stored or otherwise predetermined database 214 of cycle-accurate simulation results. In some embodiments, the ground truth performance statistic may be collected by reading a performance counter of a hardware processor 120.

The error model trainer 216 is configured to capture training simulation statistics from the simulation model 208 for the training programs 202 and to train an error model 222 with the training simulation statistics and the ground truth performance statistic. The error model 222 may be embodied as a regression model to model an error of the performance statistic generated by the simulation model 208 as compared to the ground truth performance statistic. The training simulation statistics are used as a feature vector for the error model 222. The training performance statistics may be embodied as any simulated processor events generated by the simulation model 208. In some embodiments, the error model trainer 216 may be configured to capture the training simulation statistics and train the error model 222 after completion of the simulation of the performance of the processor. In some embodiments, the error model trainer 216 may be configured to capture the training simulation statistics from the simulation model 208 during simulation for a predetermined simulation time interval. In some embodiments, those functions may be performed by one or more sub-components, such as an offline trainer 218 and/or an online trainer 220.

The error model 222 may be embodied as a machine learning regression model, such as a linear regression model (e.g., a Lasso or support vector regression (SVR) regression model) or an artificial neural network (e.g., a multi-layer perceptron, recurrent neural network, or other network). For example, an artificial neural network may be used for simulating existing hardware, because large amounts of ground truth data may be collected inexpensively from hardware devices, in turn allowing for large amounts of training data. As another example, a simpler general linear-regression model may be used for simulating hypothetical or future hardware, because collecting ground truth data may require expensive cycle-accurate simulation.

The error corrector 224 is configured to capture test simulation statistics from the simulation model 208 for the test program 204 in response to simulating of the performance of the processor. The error corrector 224 is further configured to predict an error of the simulation model 208 using the error model 222 with the test simulation statistics as a feature vector and to adjust a test performance statistic for the test program 204 based on the predicted error. In some embodiments, the error corrector 224 may be configured to capture the test simulation statistics and predict the error in response to completing the simulation of the performance of the processor. In some embodiments, the error corrector 224 may be configured to capture the test simulation statistics from the simulation model 208 and predict the error during simulation for a predetermined simulation time interval of the test program 204 in response to simulation of the performance of the processor, and to adapt the simulation model 208 based on the predicted error. In some embodiments, those functions may be performed by one or more sub-components, such as an offline corrector 226, a hybrid corrector 228, and/or an online corrector 230.

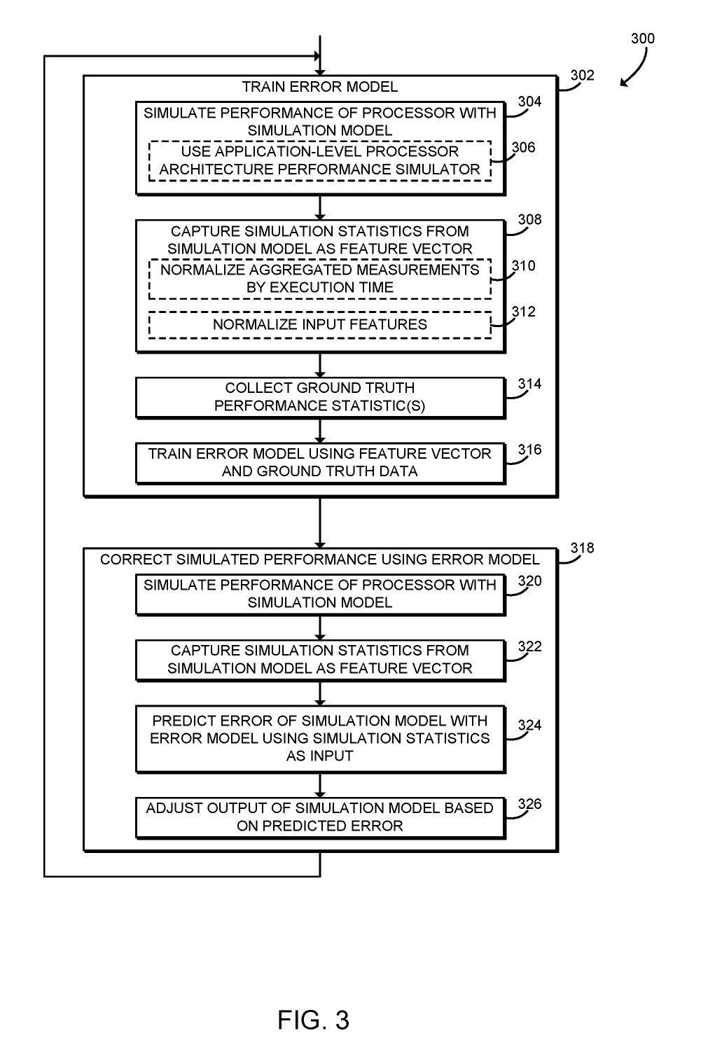

Referring now to FIG. 3, in use, the computing device 100 may execute a method 300 for processor simulation modeling. It should be appreciated that, in some embodiments, the operations of the method 300 may be performed by one or more components of the environment 200 of the computing device 100 as shown in FIG. 2. The method 300 begins in block 302, in which the computing device 100 trains the error model 222. In block 304, the computing device 100 simulates performance of a processor architecture using the simulation model 208. The computing device 100 may use the simulation model 208 to simulate one or more of the training programs 202. The simulation model 208 may generate an execution trace or other performance statistics as output based on the training programs 202. For example, cycles per instruction (CPI), power consumption, floating point operations per second (FLOPS), memory bandwidth, or other performance statistics of the simulated processor may be generated. In some embodiments, in block 306 the computing device 100 may use an application-level processor architecture performance simulator. The simulation model 208 may mechanistically or functionally deduce the performance effects of a processor architecture during execution of a multi-core application. The application-level processor architecture performance simulator may approximate or otherwise abstract the operation of various components of the simulated processor in order to reduce simulation time. For example, the simulator may include component models for one or more caches, memory management units, translation lookaside buffers, floating point units, re-order buffers, instruction decoders, mesh network, or other components of the simulated processor.

In block 308, the computing device 100 captures simulation statistics from the simulation model 208 to use as a feature vector for the error model 222. The simulation statistics may include any simulated processor event or other statistics generated by the simulation model 208 and/or its various subcomponents. As described further below, the feature vector will be used as input to the error model 222. Any such simulation statistics may be used as input features; however, in some embodiments linearly dependent or derived features may be removed to improve training behavior of the error model 222. In some embodiments, the input features may include time-independent activity factors. The simulator statistics may be pre-processed prior to model training. In some embodiments, in block 310, the computing device 100 may normalize aggregated measurements by execution time. For example, the computing device 100 may normalize event counters (such as L1 data cache misses) by execution time. In some embodiments, in block 312 the computing device 100 may normalize the input features to have a standard normal distribution.

In block 314, the computing device 100 collects ground truth performance statistics for the training programs 202. The ground truth performance statistics represent the performance statistic that will be used to model simulation error of the simulation model 208. For example, the ground truth data may be embodied as CPI, power consumption, FLOPS, memory bandwidth, or other performance statistics corresponding to the performance statistics generated by the simulation model 208. As described further below, the ground truth statistics may be generated by the cycle-accurate simulator 212, by actual hardware, or by any other accurate source. To simplify model training, the computing device 100 may collect a single performance statistic, illustratively cycles per instruction (CPI). Multiple performance statistics may be used with a multi-target learner variant.

In block 316, the computing device 100 trains the error model 222 using the feature vector (which is based on the simulation statistics from the simulation model 208) and the ground truth performance statistics. The computing device 100 trains the error model 222 to predict the error generated by the simulation model 208 as compared to the ground truth when given the simulation statistics as input. The computing device 100 may use any appropriate machine learning algorithm to train the error model 222, such as stochastic gradient descent (SGD).

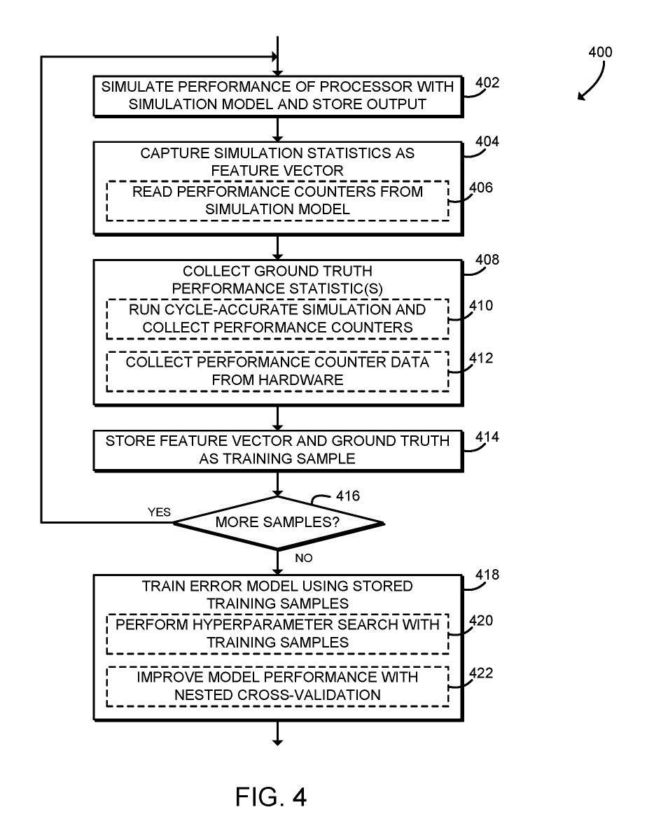

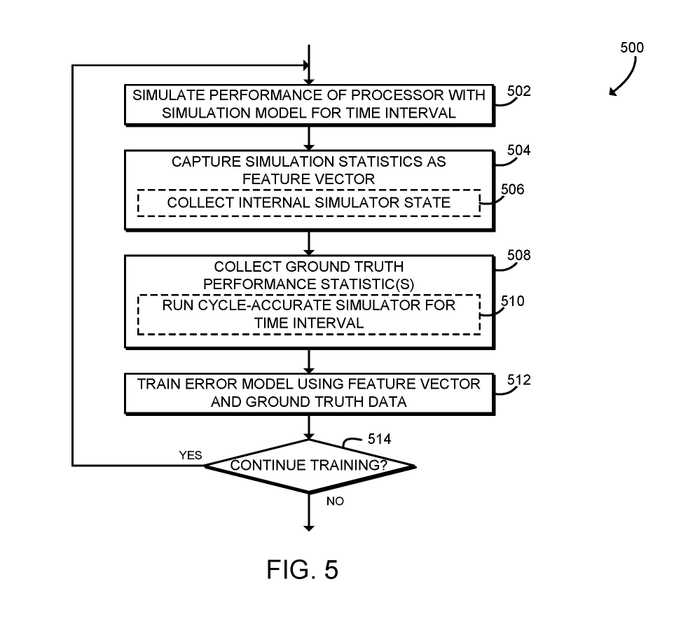

Error model training as illustrated in block 302 may be performed in an offline mode or an online mode. Offline model training is performed after completion of one or more simulation runs by the simulation model 208. One potential embodiment of a method for offline model training is described below in connection with FIG. 4. Online model training is performed at certain simulation intervals during a simulation run. One potential embodiment of a method for online model training is described below in connection with FIG. 5.

After training the error model 222, in block 318 the computing device 100 corrects simulated performance using the error model 222. In block 320, the computing device 100 simulates performance of the processor architecture during execution of the test program 204 using the simulation model 208. As described above, the simulation model 208 may generate an execution trace or other performance statistics as output based on the test program 204, including illustratively the CPI for execution of the test program 204. In block 322, the computing device 100 captures simulation statistics from the simulation model 208 to use as a feature vector for the error model 222. The computing device 100 may capture the same types and/or categories of simulation statistics and perform the same normalization used for model training as described above in connection with block 308. In block 324, the computing device 100 predicts the error of the simulation model 208 by inputting the feature vector (which is based on the simulation statistics) to the trained error model 222, which outputs a predicted error. In block 326, the computing device 100 may adjust the output of the simulation model 208 based on the predicted error. The computing device 100 may, for example, adjust a previously output value and/or adapt the execution of the simulation model 208 based on the predicted error.

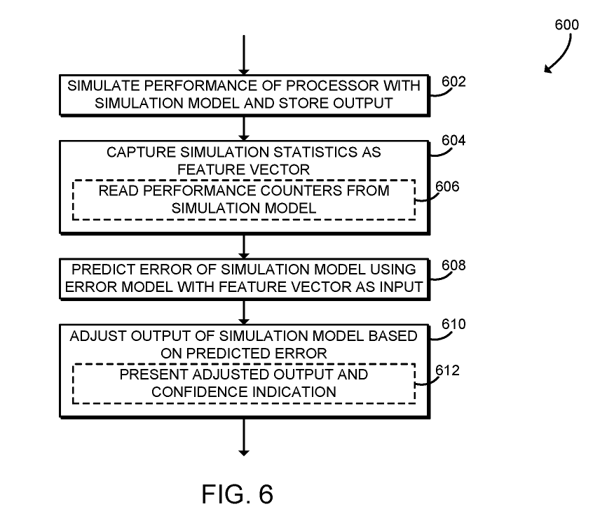

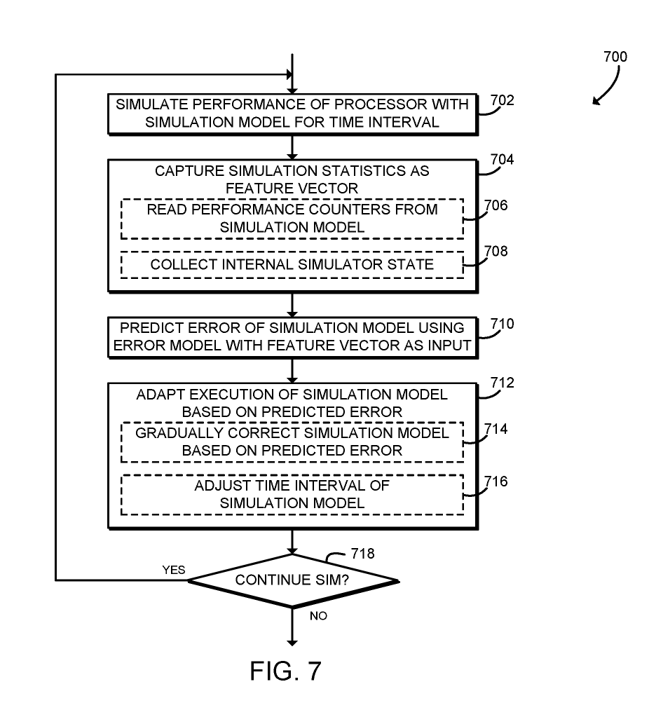

Simulation error correction as illustrated in block 318 may be performed in an offline mode, an online mode, or a hybrid mode. Offline simulation error correction is performed after completion of a simulation run and uses an error model 222 that was trained in the offline mode. One potential embodiment of a method for offline simulation error correction is described below in connection with FIG. 6. Hybrid simulation error correction is performed during a simulation run but uses an error model 222 that was trained in the offline mode. Online simulation error correction is performed during a simulation run and uses an error model 222 that was trained in the online mode. One potential embodiment of a method for hybrid/online simulation error correction is described below in connection with FIG. 7. After correcting the simulation error using the error model 222, the method 300 is completed. The computing device 100 may execute the method 300 again, for example to perform additional training and correction.

Although illustrated as performing training and error correction using separate training programs 202 and test program 204, in some embodiments the computing device 100 may perform training and correction with the same program. For example, the computing device 100 may start simulation of a program in the online training mode as described above in connection with block 302. When the error model 222 reaches a certain accuracy threshold, the computing device 100 may switch simulation of the same program to the online error correction mode as described above in connection with block 318. If accuracy of the error model 222 drops below the threshold, the computing device 100 may switch back to the online training mode, and so on.

Referring now to FIG. 4, in use, the computing device 100 may execute a method 400 for offline error model training. It should be appreciated that, in some embodiments, the operations of the method 400 may be performed by one or more components of the environment 200 of the computing device 100 as shown in FIG. 2. The method 400 begins in block 402, in which the computing device 100 simulates performance of a processor architecture using the simulation model 208 and stores output of the simulation. The computing device 100 may use the simulation model 208 to simulate one of the training programs 202.

In block 404, after completion of the simulation run, the computing device 100 captures simulation statistics of the simulation model 208 as a feature vector for the error model 222. The simulation statistics may include any simulated processor event or other statistics generated by the simulation model 208 and/or its various subcomponents and available after completion of the simulation run. For example, the simulation statistics may include floating point unit occupancy, L2 cache snoop latencies, branch prediction accuracy, or other statistics generated by the simulation model 208 and stored in the results of the simulation. Internal state of the simulation model 208 may not be available for offline training, for example due to storage space constraints. The computing device 100 may normalize or otherwise pre-process the simulation statistics as described above in connection with block 308 of FIG. 3. In some embodiments, in block 406, the computing device 100 may read one or more performance counters established by the simulation model 208. For example, the computing device 100 may read a number of cache misses, instructions executed, or other counter maintained by the simulation model 208.

In block 408, the computing device 100 collects ground truth performance statistics for the training program 202. In some embodiments, in block 410 the computing device 100 may run the cycle-accurate simulator 212 on the training program 202 and then collect data from one more performance counters established by the cycle-accurate simulator 212. In some embodiments, the computing device 100 may collect cycle-accurate simulation results from a pre-existing simulation results database 214. Re-using cycle-accurate simulation results may result in substantial reductions in simulation time. In some embodiments, in block 412 the computing device 100 may collect performance counter data from one or more physical hardware components. For example, when simulation an existing processor architecture, the computing device 100 may execute the training program 202 with the processor 120 and collect ground truth data from performance counters of the processor 120. As another example, the computing device 100 may collect ground truth data generated by hardware components of another computing device (e.g., a prototype device or other test device).

In block 414, the computing device 100 stores the feature vector and the ground truth performance statistic as a training sample. In block 416, the computing device 100 determines whether to collect additional training samples. For example, the computing device 100 may determine whether additional training programs 202 remain to be executed. If the computing device 100 determines to collect additional samples, the method 400 loops back to block 402. If the computing device 100 determines not to collect any additional samples, the method 400 advances to block 418.

In block 418, the computing device 100 trains the error model 222 using the stored training samples. The computing device 100 trains the error model 222 to predict the error in the performance statistic generated by the simulation model 208 as compared to the ground truth performance statistic, as a function of the feature vector (which is generated from the simulation statistics). As described above, the computing device 100 may use any appropriate machine learning algorithm to train the error model 222, such as stochastic gradient descent (SGD). The computing device 100 may train the error model 222 to a predetermined confidence level, such training with a 90% confidence interval. The computing device 100 may also optimize the training algorithm and/or the stored training samples to improve performance of the error model 222. In some embodiments, in block 420 the computing device 100 may perform a hyperparameter search to improve training algorithm performance In some embodiments, in block 422 the computing device 100 may improve error model 222 performance by performing nested cross-validation.

After training the error model 222, the method 400 is completed. The computing device 100 may then use the trained error model 222 to correct simulation error in an offline mode, as described further below in connection with FIG. 6 and/or to correct simulation error in a hybrid mode, as described further below in connection with FIG. 7.

Referring now to FIG. 5, in use, the computing device 100 may execute a method 500 for online error model training. It should be appreciated that, in some embodiments, the operations of the method 500 may be performed by one or more components of the environment 200 of the computing device 100 as shown in FIG. 2. The method 500 begins in block 502, in which the computing device 100 simulates performance of a processor architecture using the simulation model 208 for a simulation time interval of one of the training programs 202. For example, the computing device 100 may simulate a predetermined number of instructions, clock cycles, or other simulation interval of the training program 202.

In block 504, the computing device 100 captures simulation statistics of the simulation model 208 for the simulation interval as a feature vector for the error model 222. The simulation statistics may include any simulated processor event or other statistics generated by the simulation model 208 and/or its various subcomponents and available during the simulation run. In some embodiments, in block 506, the computing device 100 may collect the internal simulator state of the simulation model 208. For example, the computing device 100 read pipeline stage events (pipe-traces) from the simulation model 208. Of course, the computing device 100 may also collect externally available performance statistics, such as performance counters. The computing device 100 may normalize or otherwise pre-process the simulation statistics as described above in connection with block 308 of FIG. 3.

In block 508, the computing device 100 collects ground truth performance statistics for the training program 202. In some embodiments, in block 510 the computing device 100 may run the cycle-accurate simulator 212 for the same interval of the training program 202 that was simulated by the simulation model 208. For example, the computing device 100 may use the cycle-accurate simulator 212 to simulate performance of the same instruction, clock cycle, or other simulation interval that was simulated by the simulation model 208.

In block 512, the computing device 100 trains the error model 222 using the feature vector and the ground truth data. The computing device 100 trains the error model 222 to predict the error in the performance statistic generated by the simulation model 208 as compared to the ground truth performance statistic, as a function of the feature vector (which is generated from the simulation statistics). As described above, the computing device 100 may use any appropriate machine learning algorithm to train the error model 222, such as stochastic gradient descent (SGD). Note that because the feature vector and ground truth data differ between the offline and online modes, the trained error model 222 generated in each mode may also differ.

In block 514, the computing device 100 determines whether to continue training the error model 222. For example, the computing device 100 may determine whether additional instructions remain in the current training program 202 and/or whether additional training programs 202 exist. If the computing device 100 determines to continue training, the method 500 loops back to block 502 to simulate another simulation interval. If the computing device 100 determines not to continue training, the method 500 is completed. The computing device 100 may then use the trained error model 222 to correct simulation error in the online mode, as described further below in connection with FIG. 7.

Referring now to FIG. 6, in use, the computing device 100 may execute a method 600 for offline simulation error correction. It should be appreciated that, in some embodiments, the operations of the method 600 may be performed by one or more components of the environment 200 of the computing device 100 as shown in FIG. 2. The method 600 begins in block 602, in which the computing device 100 simulates performance of a processor architecture using the simulation model 208 and stores output of the simulation. The computing device 100 may use the simulation model 208 to simulate the test program 204.

In block 604, after completion of the simulation run, the computing device 100 captures simulation statistics of the simulation model 208 as a feature vector for the error model 222. As described above, the simulation statistics may include any simulated processor event or other statistics generated by the simulation model 208 and/or its various subcomponents and available after completion of the simulation run. The computing device 100 may normalize or otherwise pre-process the simulation statistics as described above in connection with block 322 of FIG. 3. In some embodiments, in block 606, the computing device 100 may read one or more performance counters established by the simulation model 208. For example, the computing device 100 may read a number of cache misses, instructions executed, or other counter maintained by the simulation model 208.

In block 608, the computing device 100 predicts the error of the simulation model 208 by inputting the feature vector (which is based on the simulation statistics) to the error model 222, which outputs a predicted error. In block 610, the computing device 100 adjust the output of the simulation model 208 based on the predicted error. The computing device 100 may adjust a performance statistic generated by the simulation model 208 (e.g., CPI) by the predicted error generated by the error model 222. In some embodiments, in block 612 the computing device 100 may present the adjusted output and an associated confidence indication. The confidence level may be determined during the training phase of the error model 222. For example, in an illustrative embodiment the simulation model 208 may determine an instructions per cycle (IPC) value for the test program 204, which is illustratively the numeric value 0.4. Continuing that example, the error model 222 may be pre-trained with a 90% confidence interval. The pre-trained error model 222 may predict an IPC error of −0.1 based on the simulation statistics from the simulation model 208. Thus, in that example, the computing device 100 may present a simulated IPC of 0.4 together with a 90%-accurate error corrected IPC of 0.3. After adjusting the simulation output, the method 600 is completed.

Referring now to FIG. 7, in use, the computing device 100 may execute a method 700 for hybrid/online simulation error correction. It should be appreciated that, in some embodiments, the operations of the method 700 may be performed by one or more components of the environment 200 of the computing device 100 as shown in FIG. 2. The method 700 begins in block 702, in which the computing device 100 in which the computing device 100 simulates performance of a processor architecture using the simulation model 208 for a simulation time interval of the test programs 204. For example, the computing device 100 may simulate a predetermined number of instructions, clock cycles, or other simulation interval.

In block 704, the computing device 100 captures simulation statistics of the simulation model 208 as a feature vector for the error model 222. The simulation statistics may include any simulated processor event or other statistics generated by the simulation model 208 and/or its various subcomponents and available during the simulation run. The computing device 100 may normalize or otherwise pre-process the simulation statistics as described above in connection with block 322 of FIG. 3. In some embodiments, in block 706, the computing device 100 may read one or more performance counters established by the simulation model 208. For example, the computing device 100 may read a number of cache misses, instructions executed, or other counter maintained by the simulation model 208. The computing device 100 may read the performance counter when operating in the hybrid error correction mode, using an error model 222 that was trained in the offline mode as described above in connection with FIG. 4. In some embodiments, in block 708, the computing device 100 may collect the internal simulator state of the simulation model 208. For example, the computing device 100 read pipeline stage events (pipe-traces) from the simulation model 208. The computing device 100 may collect the internal state when operating in the online error correction mode, using an error model 222 that was trained in the online mode as described above in connection with FIG. 5.

In block 710, the computing device 100 predicts the error of the simulation model 208 by inputting the feature vector (which is based on the simulation statistics) to the error model 222, which outputs a predicted error. In block 712, the computing device 100 adapts the execution of the simulation model 208 based on the predicted error. The computing device 100 may adjust, during simulation, one or more simulation parameters to correct a performance statistic (e.g., CPI) generated by the simulation model 208 based on the predicted error. Thus, the error predicted by the error model 222 may be used as feedback to improve the accuracy of the simulation model 208. In some embodiments, in block 714 the computing device 100 may gradually correct one or more parameters of the simulation model 208 based on the predicted error. In some embodiments, in block 716 the computing device 100 may adjust a time parameter of the simulation model 208, such as a simulated clock interval. For example, the error model 222 may predict an instructions per cycle (IPC) error of +0.1. To adapt to the predicted IPC error, the computing device 100 may turn back the simulation time by a small amount (e.g., a few nanoseconds). However, in some embodiments, it may not be possible to turn back simulation time of the simulation model 208. Thus, the computing device 100 may adjust the simulated clock increment used by the simulation model 208 by a small amount to gradually remove the predicted error. Note that the simulation model 208 may use a simulated clock interval or other time interval that is different from the simulation time interval used by the error model 222.

In block 718, the computing device 100 determines whether to continue simulation. For example, the computing device 100 may determine whether additional instructions remain in the test program 204. If so, the method 700 loops back to block 702 to continue simulating performance of the processor. If the computing device 100 determines not to continue simulation, the method 700 is completed.

It should be appreciated that, in some embodiments, the methods 300, 400, 500, 600, and/or 700 may be embodied as various instructions stored on a computer-readable media, which may be executed by the processor 120, the I/O subsystem 122, and/or other components of a computing device 100 to cause the computing device 100 to perform the respective method 300, 400, 500, 600, and/or 700. The computer-readable media may be embodied as any type of media capable of being read by the computing device 100 including, but not limited to, the memory 124, the data storage device 126, firmware devices, and/or other media.

### EXAMPLES

Illustrative examples of the technologies disclosed herein are provided below. An embodiment of the technologies may include any one or more, and any combination of, the examples described below.

Example 1 includes a computing device for processor performance simulation, the computing device comprising: a performance simulator to simulate performance of a processor for a training program with a simulation model to determine a training performance statistic; a ground truth manager to collect a ground truth performance statistic of the processor for the training program; and an error model trainer to (i) capture training simulation statistics from the simulation model for the training program in response to simulation of the performance of the processor, (ii) train an error model with the training simulation statistics and the ground truth performance statistic, wherein error model comprises a regression model to model an error of the performance statistic generated by the simulation model compared to the ground truth performance statistic, and wherein the training simulation statistics comprise a feature vector for the error model.

Example 2 includes the subject matter of Example 1, and wherein to simulate the performance of the processor comprises to execute an application-level processor architecture performance simulator.

Example 3 includes the subject matter of any of Examples 1 and 2, and wherein the training performance statistic comprises a cycles per instruction value, a floating point operations per second value, a power consumption value, or a memory bandwidth value.

Example 4 includes the subject matter of any of Examples 1-3, and wherein the error model comprises an artificial neural network.

Example 5 includes the subject matter of any of Examples 1-4, and wherein the error model comprises a linear regression model.

Example 6 includes the subject matter of any of Examples 1-5, and wherein to capture the training simulation statistics comprises to normalize an aggregated performance measurement by execution time.

Example 7 includes the subject matter of any of Examples 1-6, and wherein the training simulation statistics are indicative of one or more simulated processor events generated by the simulation model.

Example 8 includes the subject matter of any of Examples 1-7, and further comprising an error corrector, wherein: the performance simulator is further to simulate performance of the processor for a test program with the simulation model to determine a test performance statistic; and the error corrector is to (i) capture test simulation statistics from the simulation model for the test program in response to simulation of the performance of the processor, (ii) predict a predicted error of the simulation model using the error model with the test simulation statistics as a feature vector in response to training of the error model, and (iii) adjust the test performance statistic based on the predicted error.

Example 9 includes the subject matter of any of Examples 1-8, and wherein: the performance simulator is further to (i) complete simulation of the performance of the processor for the training program, and (ii) store the training simulation statistics and the training performance statistics in response to completion of the simulation; and to capture the training simulation statistics comprises to capture the training simulation statistics in response to the completion of the simulation of the performance of the processor.

Example 10 includes the subject matter of any of Examples 1-9, and wherein to capture the training simulation statistics comprises to read a performance counter of the simulation model.

Example 11 includes the subject matter of any of Examples 1-10, and wherein to collect the ground truth performance statistic comprises to execute a cycle-accurate simulation of the training program.

Example 12 includes the subject matter of any of Examples 1-11, and wherein to collect the ground truth performance statistic comprises to read a predetermined database of cycle-accurate simulation results.

Example 13 includes the subject matter of any of Examples 1-12, and wherein to collect the ground truth performance statistic comprises to read a performance counter of a hardware processor.

Example 14 includes the subject matter of any of Examples 1-13, and further comprising an error corrector, wherein: the performance simulator is further to (i) simulate performance of the processor for a test program with the simulation model to determine a test performance statistic and (ii) complete simulation of the performance of the processor for the test program; and the error corrector is to (i) capture test simulation statistics from the simulation model for the test program in response to completion of the simulation of the performance of the processor, (ii) predict a predicted error of the simulation model using the error model with the test simulation statistics as a feature vector in response to training of the error model and in response to the completion of the simulation of the performance of the processor for the test program, and (iii) adjust the test performance statistic based on the predicted error.

Example 15 includes the subject matter of any of Examples 1-14, and further comprising an error corrector, wherein: the performance simulator is further to simulate performance of the processor for a time interval of a test program with the simulation model to determine a test performance statistic; and the error corrector is to (i) capture test simulation statistics from the simulation model for the time interval of the test program in response to simulation of the performance of the processor, (ii) predict a predicted error of the simulation model using the error model with the test simulation statistics as a feature vector in response to capture of the test simulation statistics and training of the error model, and (iii) adapt the simulation model based on the predicted error.

Example 16 includes the subject matter of any of Examples 1-15, and wherein: to simulate the performance of the processor for the training program comprises to simulate performance of the processor for a time interval of the training program; to capture the training simulation statistics comprises to capture the training simulation statistics from the simulation model for the time interval; to collect the ground truth performance statistic comprises to collect the ground truth performance statistic for the time interval of the training program; and to train the error model comprises to train the error model in response to simulation of the performance of the processor for the time interval.

Example 17 includes the subject matter of any of Examples 1-16, and wherein to capture the training simulation statistics comprises to capture an internal simulator state of the simulation model.

Example 18 includes the subject matter of any of Examples 1-17, and wherein to collect the ground truth performance statistic comprises to execute a cycle-accurate simulation of the time interval of the training program.

Example 19 includes the subject matter of any of Examples 1-18, and further comprising an error corrector, wherein: the performance simulator is further to (i) simulate performance of the processor for a time interval of a test program with the simulation model to determine a test performance statistic; and the error corrector is to (i) capture test simulation statistics from the simulation model for the time interval of the test program in response to simulation of the performance of the processor, (ii) predict a predicted error of the simulation model using the error model with the test simulation statistics as a feature vector in response to capture of the test simulation statistics, and (iii) adapt the simulation model based on the predicted error.

Example 20 includes the subject matter of any of Examples 1-19, and wherein to adapt the simulation model comprises to gradually correct a parameter of the simulation model based on the predicted error.

Example 21 includes the subject matter of any of Examples 1-20, and wherein to adapt the simulation model comprises to adjust a simulation interval of the simulation model based on the predicted error.

Example 22 includes a method for processor performance simulation, the method comprising: simulating, by a computing device, performance of a processor for a training program with a simulation model to determine a training performance statistic; capturing, by the computing device, training simulation statistics from the simulation model for the training program in response to simulating the performance of the processor; collecting, by the computing device, a ground truth performance statistic of the processor for the training program; and training, by the computing device, an error model with the training simulation statistics and the ground truth performance statistic, wherein error model comprises a regression model to model an error of the performance statistic generated by the simulation model compared to the ground truth performance statistic, and wherein the training simulation statistics comprise a feature vector for the error model.

Example 23 includes the subject matter of Example 22, and wherein simulating the performance of the processor comprises executing an application-level processor architecture performance simulator.

Example 24 includes the subject matter of any of Examples 22 and 23, and wherein the training performance statistic comprises a cycles per instruction value, a floating point operations per second value, a power consumption value, or a memory bandwidth value.

Example 25 includes the subject matter of any of Examples 22-24, and wherein the error model comprises an artificial neural network.

Example 26 includes the subject matter of any of Examples 22-25, and wherein the error model comprises a linear regression model.

Example 27 includes the subject matter of any of Examples 22-26, and wherein capturing the training simulation statistics comprises normalizing an aggregated performance measurement by execution time.

Example 28 includes the subject matter of any of Examples 22-27, and wherein the training simulation statistics are indicative of one or more simulated processor events generated by the simulation model.

Example 29 includes the subject matter of any of Examples 22-28, and further comprising: simulating, by the computing device, performance of the processor for a test program with the simulation model to determine a test performance statistic; capturing, by the computing device, test simulation statistics from the simulation model for the test program in response to simulating the performance of the processor; predicting, by the computing device, a predicted error of the simulation model using the error model with the test simulation statistics as a feature vector in response to training the error model; and adjusting, by the computing device, the test performance statistic based on the predicted error.

Example 30 includes the subject matter of any of Examples 22-29, and further comprising: completing, by the computing device, simulation of the performance of the processor for the training program; and storing, by the computing device, the training simulation statistics and the training performance statistics in response to completing the simulation; wherein capturing the training simulation statistics comprises capturing the training simulation statistics in response to completing the simulation of the performance of the processor.

Example 31 includes the subject matter of any of Examples 22-30, and wherein capturing the training simulation statistics comprises reading a performance counter of the simulation model.

Example 32 includes the subject matter of any of Examples 22-31, and wherein collecting the ground truth performance statistic comprises executing a cycle-accurate simulation of the training program.

Example 33 includes the subject matter of any of Examples 22-32, and wherein collecting the ground truth performance statistic comprises reading a predetermined database of cycle-accurate simulation results.

Example 34 includes the subject matter of any of Examples 22-33, and wherein collecting the ground truth performance statistic comprises reading a performance counter of a hardware processor.

Example 35 includes the subject matter of any of Examples 22-34, and further comprising: simulating, by the computing device, performance of the processor for a test program with the simulation model to determine a test performance statistic; completing, by the computing device, simulation of the performance of the processor for the test program; capturing, by the computing device, test simulation statistics from the simulation model for the test program in response to completing simulation of the performance of the processor; predicting, by the computing device, a predicted error of the simulation model using the error model with the test simulation statistics as a feature vector in response to training the error model and in response to completing the simulation of the performance of the processor for the test program; and adjusting, by the computing device, the test performance statistic based on the predicted error.

Example 36 includes the subject matter of any of Examples 22-35, and further comprising: simulating, by the computing device, performance of the processor for a time interval of a test program with the simulation model to determine a test performance statistic; capturing, by the computing device, test simulation statistics from the simulation model for the time interval of the test program in response to simulating the performance of the processor; predicting, by the computing device, a predicted error of the simulation model using the error model with the test simulation statistics as a feature vector in response to capturing the test simulation statistics and training the error model; and adapting, by the computing device, the simulation model based on the predicted error.

Example 37 includes the subject matter of any of Examples 22-36, and wherein: simulating the performance of the processor for the training program comprises simulating performance of the processor for a time interval of the training program; capturing the training simulation statistics comprises capturing the training simulation statistics from the simulation model for the time interval; collecting the ground truth performance statistic comprises collecting the ground truth performance statistic for the time interval of the training program; and training the error model comprises training the error model in response to simulating the performance of the processor for the time interval.

Example 38 includes the subject matter of any of Examples 22-37, and wherein capturing the training simulation statistics comprises capturing an internal simulator state of the simulation model.

Example 39 includes the subject matter of any of Examples 22-38, and wherein collecting the ground truth performance statistic comprises executing a cycle-accurate simulation of the time interval of the training program.

Example 40 includes the subject matter of any of Examples 22-39, and further comprising: simulating, by the computing device, performance of the processor for a time interval of a test program with the simulation model to determine a test performance statistic; capturing, by the computing device, test simulation statistics from the simulation model for the time interval of the test program in response to simulating the performance of the processor; predicting, by the computing device, a predicted error of the simulation model using the error model with the test simulation statistics as a feature vector in response to capturing the test simulation statistics; and adapting, by the computing device, the simulation model based on the predicted error.

Example 41 includes the subject matter of any of Examples 22-40, and wherein adapting the simulation model comprises gradually correcting a parameter of the simulation model based on the predicted error.

Example 42 includes the subject matter of any of Examples 22-41, and wherein adapting the simulation model comprises adjusting a simulation interval of the simulation model based on the predicted error.

Example 43 includes a computing device comprising: a processor; and a memory having stored therein a plurality of instructions that when executed by the processor cause the computing device to perform the method of any of Examples 22-42.

Example 44 includes one or more machine readable storage media comprising a plurality of instructions stored thereon that in response to being executed result in a computing device performing the method of any of Examples 22-42.

Example 45 includes a computing device comprising means for performing the method of any of Examples 22-42.

Example 46 includes a computing device for processor performance simulation, the computing device comprising: means for simulating performance of a processor for a training program with a simulation model to determine a training performance statistic; means for capturing training simulation statistics from the simulation model for the training program in response to simulating the performance of the processor; means for collecting a ground truth performance statistic of the processor for the training program; and means for training an error model with the training simulation statistics and the ground truth performance statistic, wherein error model comprises a regression model to model an error of the performance statistic generated by the simulation model compared to the ground truth performance statistic, and wherein the training simulation statistics comprise a feature vector for the error model.

Example 47 includes the subject matter of Example 46, and wherein the means for simulating the performance of the processor comprises means for executing an application-level processor architecture performance simulator.

Example 48 includes the subject matter of any of Examples 46 and 47, and wherein the training performance statistic comprises a cycles per instruction value, a floating point operations per second value, a power consumption value, or a memory bandwidth value.

Example 49 includes the subject matter of any of Examples 46-48, and wherein the error model comprises an artificial neural network.

Example 50 includes the subject matter of any of Examples 46-49, and wherein the error model comprises a linear regression model.

Example 51 includes the subject matter of any of Examples 46-50, and wherein the means for capturing the training simulation statistics comprises means for normalizing an aggregated performance measurement by execution time.

Example 52 includes the subject matter of any of Examples 46-51, and wherein the training simulation statistics are indicative of one or more simulated processor events generated by the simulation model.

Example 53 includes the subject matter of any of Examples 46-52, and further comprising: means for simulating performance of the processor for a test program with the simulation model to determine a test performance statistic; means for capturing test simulation statistics from the simulation model for the test program in response to simulating the performance of the processor; means for predicting a predicted error of the simulation model using the error model with the test simulation statistics as a feature vector in response to training the error model; and means for adjusting the test performance statistic based on the predicted error.

Example 54 includes the subject matter of any of Examples 46-53, and further comprising: means for completing simulation of the performance of the processor for the training program; and means for storing the training simulation statistics and the training performance statistics in response to completing the simulation; wherein the means for capturing the training simulation statistics comprises means for capturing the training simulation statistics in response to completing the simulation of the performance of the processor.

Example 55 includes the subject matter of any of Examples 46-54, and wherein the means for capturing the training simulation statistics comprises means for reading a performance counter of the simulation model.

Example 56 includes the subject matter of any of Examples 46-55, and wherein the means for collecting the ground truth performance statistic comprises means for executing a cycle-accurate simulation of the training program.

Example 57 includes the subject matter of any of Examples 46-56, and wherein the means for collecting the ground truth performance statistic comprises means for reading a predetermined database of cycle-accurate simulation results.

Example 58 includes the subject matter of any of Examples 46-57, and wherein the means for collecting the ground truth performance statistic comprises means for reading a performance counter of a hardware processor.

Example 59 includes the subject matter of any of Examples 46-58, and further comprising: means for simulating performance of the processor for a test program with the simulation model to determine a test performance statistic; means for completing simulation of the performance of the processor for the test program; means for capturing test simulation statistics from the simulation model for the test program in response to completing simulation of the performance of the processor; means for predicting a predicted error of the simulation model using the error model with the test simulation statistics as a feature vector in response to training the error model and in response to completing the simulation of the performance of the processor for the test program; and means for adjusting the test performance statistic based on the predicted error.

Example 60 includes the subject matter of any of Examples 46-59, and further comprising: means for simulating performance of the processor for a time interval of a test program with the simulation model to determine a test performance statistic; means for capturing test simulation statistics from the simulation model for the time interval of the test program in response to simulating the performance of the processor; means for predicting a predicted error of the simulation model using the error model with the test simulation statistics as a feature vector in response to capturing the test simulation statistics and training the error model; and means for adapting the simulation model based on the predicted error.

Example 61 includes the subject matter of any of Examples 46-60, and wherein: the means for simulating the performance of the processor for the training program comprises means for simulating performance of the processor for a time interval of the training program; the means for capturing the training simulation statistics comprises means for capturing the training simulation statistics from the simulation model for the time interval; the means for collecting the ground truth performance statistic comprises means for collecting the ground truth performance statistic for the time interval of the training program; and the means for training the error model comprises means for training the error model in response to simulating the performance of the processor for the time interval.

Example 62 includes the subject matter of any of Examples 46-61, and wherein the means for capturing the training simulation statistics comprises means for capturing an internal simulator state of the simulation model.

Example 63 includes the subject matter of any of Examples 46-62, and wherein the means for collecting the ground truth performance statistic comprises means for executing a cycle-accurate simulation of the time interval of the training program.

Example 64 includes the subject matter of any of Examples 46-63, and further comprising: means for simulating performance of the processor for a time interval of a test program with the simulation model to determine a test performance statistic; means for capturing test simulation statistics from the simulation model for the time interval of the test program in response to simulating the performance of the processor; means for predicting a predicted error of the simulation model using the error model with the test simulation statistics as a feature vector in response to capturing the test simulation statistics; and means for adapting the simulation model based on the predicted error.

Example 65 includes the subject matter of any of Examples 46-64, and wherein the means for adapting the simulation model comprises gradually means for correcting a parameter of the simulation model based on the predicted error.

Example 66 includes the subject matter of any of Examples 46-65, and wherein the means for adapting the simulation model comprises means for adjusting a simulation interval of the simulation model based on the predicted error.

1. A computing device for processor performance simulation, the computing device comprising:
a performance simulator to simulate performance of a processor for a training program with a simulation model to determine a training performance statistic;
a ground truth manager to collect a ground truth performance statistic of the processor for the training program; and
an error model trainer to (i) capture training simulation statistics from the simulation model for the training program in response to simulation of the performance of the processor, (ii) train an error model with the training simulation statistics and the ground truth performance statistic, wherein error model comprises a regression model to model an error of the performance statistic generated by the simulation model compared to the ground truth performance statistic, and wherein the training simulation statistics comprise a feature vector for the error model.

2. The computing device of claim 1, wherein to simulate the performance of the processor comprises to execute an application-level processor architecture performance simulator.

3. The computing device of claim 1, wherein the training simulation statistics are indicative of one or more simulated processor events generated by the simulation model.

4. The computing device of claim 1, further comprising an error corrector, wherein:
the performance simulator is further to simulate performance of the processor for a test program with the simulation model to determine a test performance statistic; and
the error corrector is to (i) capture test simulation statistics from the simulation model for the test program in response to simulation of the performance of the processor, (ii) predict a predicted error of the simulation model using the error model with the test simulation statistics as a feature vector in response to training of the error model, and (iii) adjust the test performance statistic based on the predicted error.

5. The computing device of claim 1, wherein:
the performance simulator is further to (i) complete simulation of the performance of the processor for the training program, and (ii) store the training simulation statistics and the training performance statistics in response to completion of the simulation; and
to capture the training simulation statistics comprises to capture the training simulation statistics in response to the completion of the simulation of the performance of the processor.

6. The computing device of claim 5, further comprising an error corrector, wherein:
the performance simulator is further to (i) simulate performance of the processor for a test program with the simulation model to determine a test performance statistic and (ii) complete simulation of the performance of the processor for the test program; and
the error corrector is to (i) capture test simulation statistics from the simulation model for the test program in response to completion of the simulation of the performance of the processor, (ii) predict a predicted error of the simulation model using the error model with the test simulation statistics as a feature vector in response to training of the error model and in response to the completion of the simulation of the performance of the processor for the test program, and (iii) adjust the test performance statistic based on the predicted error.

7. The computing device of claim 5, further comprising an error corrector, wherein:
the performance simulator is further to simulate performance of the processor for a time interval of a test program with the simulation model to determine a test performance statistic; and
the error corrector is to (i) capture test simulation statistics from the simulation model for the time interval of the test program in response to simulation of the performance of the processor, (ii) predict a predicted error of the simulation model using the error model with the test simulation statistics as a feature vector in response to capture of the test simulation statistics and training of the error model, and (iii) adapt the simulation model based on the predicted error.

8. The computing device of claim 1, wherein:
to simulate the performance of the processor for the training program comprises to simulate performance of the processor for a time interval of the training program;
to capture the training simulation statistics comprises to capture the training simulation statistics from the simulation model for the time interval;
to collect the ground truth performance statistic comprises to collect the ground truth performance statistic for the time interval of the training program; and
to train the error model comprises to train the error model in response to simulation of the performance of the processor for the time interval.

9. The computing device of claim 8, wherein to capture the training simulation statistics comprises to capture an internal simulator state of the simulation model.

10. The computing device of claim 8, further comprising an error corrector, wherein:
the performance simulator is further to (i) simulate performance of the processor for a time interval of a test program with the simulation model to determine a test performance statistic; and
the error corrector is to (i) capture test simulation statistics from the simulation model for the time interval of the test program in response to simulation of the performance of the processor, (ii) predict a predicted error of the simulation model using the error model with the test simulation statistics as a feature vector in response to capture of the test simulation statistics, and (iii) adapt the simulation model based on the predicted error.

11. The computing device of claim 10, wherein to adapt the simulation model comprises to gradually correct a parameter of the simulation model based on the predicted error.

12. A method for processor performance simulation, the method comprising:
simulating, by a computing device, performance of a processor for a training program with a simulation model to determine a training performance statistic;
capturing, by the computing device, training simulation statistics from the simulation model for the training program in response to simulating the performance of the processor;
collecting, by the computing device, a ground truth performance statistic of the processor for the training program; and
training, by the computing device, an error model with the training simulation statistics and the ground truth performance statistic, wherein error model comprises a regression model to model an error of the performance statistic generated by the simulation model compared to the ground truth performance statistic, and wherein the training simulation statistics comprise a feature vector for the error model.

13. The method of claim 12, further comprising:
simulating, by the computing device, performance of the processor for a test program with the simulation model to determine a test performance statistic;
capturing, by the computing device, test simulation statistics from the simulation model for the test program in response to simulating the performance of the processor;
predicting, by the computing device, a predicted error of the simulation model using the error model with the test simulation statistics as a feature vector in response to training the error model; and
adjusting, by the computing device, the test performance statistic based on the predicted error.

14. The method of claim 12, further comprising:
completing, by the computing device, simulation of the performance of the processor for the training program; and
storing, by the computing device, the training simulation statistics and the training performance statistics in response to completing the simulation;
wherein capturing the training simulation statistics comprises capturing the training simulation statistics in response to completing the simulation of the performance of the processor.

15. The method of claim 14, further comprising:
simulating, by the computing device, performance of the processor for a test program with the simulation model to determine a test performance statistic;
completing, by the computing device, simulation of the performance of the processor for the test program;
capturing, by the computing device, test simulation statistics from the simulation model for the test program in response to completing simulation of the performance of the processor;
predicting, by the computing device, a predicted error of the simulation model using the error model with the test simulation statistics as a feature vector in response to training the error model and in response to completing the simulation of the performance of the processor for the test program; and
adjusting, by the computing device, the test performance statistic based on the predicted error.

16. The method of claim 14, further comprising:
simulating, by the computing device, performance of the processor for a time interval of a test program with the simulation model to determine a test performance statistic;
capturing, by the computing device, test simulation statistics from the simulation model for the time interval of the test program in response to simulating the performance of the processor;
predicting, by the computing device, a predicted error of the simulation model using the error model with the test simulation statistics as a feature vector in response to capturing the test simulation statistics and training the error model; and
adapting, by the computing device, the simulation model based on the predicted error.

17. The method of claim 12, wherein:
simulating the performance of the processor for the training program comprises simulating performance of the processor for a time interval of the training program;
capturing the training simulation statistics comprises capturing the training simulation statistics from the simulation model for the time interval;
collecting the ground truth performance statistic comprises collecting the ground truth performance statistic for the time interval of the training program; and
training the error model comprises training the error model in response to simulating the performance of the processor for the time interval.

18. The method of claim 17, further comprising:
simulating, by the computing device, performance of the processor for a time interval of a test program with the simulation model to determine a test performance statistic;
capturing, by the computing device, test simulation statistics from the simulation model for the time interval of the test program in response to simulating the performance of the processor;
predicting, by the computing device, a predicted error of the simulation model using the error model with the test simulation statistics as a feature vector in response to capturing the test simulation statistics; and
adapting, by the computing device, the simulation model based on the predicted error.

19. One or more computer-readable storage media comprising a plurality of instructions that in response to being executed cause a computing device to:
simulate performance of a processor for a training program with a simulation model to determine a training performance statistic;
capture training simulation statistics from the simulation model for the training program in response to simulating the performance of the processor;
collect a ground truth performance statistic of the processor for the training program; and
train an error model with the training simulation statistics and the ground truth performance statistic, wherein error model comprises a regression model to model an error of the performance statistic generated by the simulation model compared to the ground truth performance statistic, and wherein the training simulation statistics comprise a feature vector for the error model.

20. The one or more computer-readable storage media of claim 19, further comprising a plurality of instructions that in response to being executed cause the computing device to:
simulate performance of the processor for a test program with the simulation model to determine a test performance statistic;
capture test simulation statistics from the simulation model for the test program in response to simulating the performance of the processor;
predict a predicted error of the simulation model using the error model with the test simulation statistics as a feature vector in response to training the error model; and
adjust the test performance statistic based on the predicted error.

21. The one or more computer-readable storage media of claim 19, further comprising a plurality of instructions that in response to being executed cause the computing device to:
complete simulation of the performance of the processor for the training program; and
store the training simulation statistics and the training performance statistics in response to completing the simulation;
wherein to capture the training simulation statistics comprises to capture the training simulation statistics in response to completing the simulation of the performance of the processor.

22. The one or more computer-readable storage media of claim 21, further comprising a plurality of instructions that in response to being executed cause the computing device to:
simulate performance of the processor for a test program with the simulation model to determine a test performance statistic;
complete simulation of the performance of the processor for the test program;
capture test simulation statistics from the simulation model for the test program in response to completing simulation of the performance of the processor;
predict a predicted error of the simulation model using the error model with the test simulation statistics as a feature vector in response to training the error model and in response to completing the simulation of the performance of the processor for the test program; and
adjust the test performance statistic based on the predicted error.

23. The one or more computer-readable storage media of claim 21, further comprising a plurality of instructions that in response to being executed cause the computing device to:
simulate performance of the processor for a time interval of a test program with the simulation model to determine a test performance statistic;
capture test simulation statistics from the simulation model for the time interval of the test program in response to simulating the performance of the processor;
predict a predicted error of the simulation model using the error model with the test simulation statistics as a feature vector in response to capturing the test simulation statistics and training the error model; and
adapt the simulation model based on the predicted error.

24. The one or more computer-readable storage media of claim 19, wherein:
to simulate the performance of the processor for the training program comprises simulating performance of the processor for a time interval of the training program;
to capture the training simulation statistics comprises capturing the training simulation statistics from the simulation model for the time interval;
to collect the ground truth performance statistic comprises collecting the ground truth performance statistic for the time interval of the training program; and
to train the error model comprises training the error model in response to simulating the performance of the processor for the time interval.

25. The one or more computer-readable storage media of claim 24, further comprising a plurality of instructions that in response to being executed cause the computing device to:
simulate performance of the processor for a time interval of a test program with the simulation model to determine a test performance statistic;
capture test simulation statistics from the simulation model for the time interval of the test program in response to simulating the performance of the processor;
predict a predicted error of the simulation model using the error model with the test simulation statistics as a feature vector in response to capturing the test simulation statistics; and
adapt the simulation model based on the predicted error.
